(19) United States
(12) Patent Application Publication
(10) Pub. No.: US 2014/0229307 A1
(43) Pub. Date: Aug. 14, 2014

(54) METHOD OF IDENTIFYING OUTLIERS IN ITEM CATEGORIES

(71) Applicants: Surya Teja Kallumadi, Manhattan, KS (US); Manas Haribhai Somaiya, Sunnyvale, CA (US)

(72) Inventors: Surya Teja Kallumadi, Manhattan, KS (US); Manas Haribhai Somaiya, Sunnyvale, CA (US)

(73) Assignee: eBay Inc., San Jose, CA (US)

(21) Appl. No.: 13/765,521

(22) Filed: Feb. 12, 2013

(51) Int. Cl. G06Q 30/06

(52) U.S. Cl. CPC G06Q 30/0601
USPC 705/26.1

(57) ABSTRACT

A system and method of identifying outliers in item categories are described. A pairwise similarity measurement may be determined between each item listing in a plurality of item listings based on a comparison of at least one feature of each item listing. At least one outlier among the plurality of item listings may be determined using the pairwise similarity measurements. The feature(s) may comprise at least one feature from a group of features consisting of: a title, an image, a price, an attribute, and a description. Each item listing in the plurality of item listings may belong to the same leaf or non-leaf category in a network-based marketplace or publication system. The outlier(s) may be determined using at least one clustering algorithm. The clustering algorithm(s) may comprise an agglomerative hierarchical clustering algorithm and/or a density-based clustering algorithm.

### TECHNICAL FIELD

The present application relates generally to the technical field of data processing, and, in various embodiments, to systems and methods of identifying outliers in item categories.

### BACKGROUND

A network-based marketplace or publication system usually features a taxonomy for a hierarchical classification of items available for sale in order to facilitate searching and browsing of item listings. This taxonomy may be arranged in a tree or graph where each node represents a distinct item category. In a tree-based taxonomy, the item categories can be leaf categories or non-leaf categories. When listing an item in a network-based marketplace or publication system, a seller may miscategorize the item. This miscategorization may be the result of a mistake or may be intentional. Additionally, an item may simply be very rare for the category under which it is listed. These miscategorized and rare listings may be considered to be outliers, the existence of which may negatively affect the shopping experience for users.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with some embodiments;

FIG. 2 is a block diagram depicting various components of a network-based publication system, in accordance with some embodiments;

FIG. 3 is a block diagram depicting various tables that may be maintained within a database, in accordance with some embodiments;

FIG. 4 is a block diagram illustrating an outlier identification system, in accordance with some embodiments;

FIG. 5 illustrates an item listing, in accordance with some embodiments;

FIG. 6 illustrates a graphical representation of an agglomerative hierarchical clustering algorithm, in accordance with some embodiments;

FIG. 7 illustrates a graphical representation of a density-based clustering algorithm, in accordance with some embodiments;

FIG. 8 is a flowchart illustrating a method of identifying outliers, in accordance with some embodiments;

FIG. 9 is a flowchart illustrating another method of identifying outliers, in accordance with some embodiments;

FIG. 10 is a flowchart illustrating yet another method of identifying outliers, in accordance with some embodiments;

FIG. 11 is a flowchart illustrating yet another method of identifying outliers, in accordance with some embodiments; and

FIG. 12 shows a diagrammatic representation of a machine in the example form of a computer system within which a set of instructions may be executed to cause the machine to perform any one or more of the methodologies discussed herein, in accordance with some embodiments.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes systems and methods of identifying outliers in item categories. These outliers may be detected within various leaf and/or non-leaf categories in the inventory of a network-based marketplace or publication system. By demoting or eliminating outliers, improvements may be made to the automated classification of subsequent items and the user experience on search result pages and browse result pages for the inventory.

In some embodiments, a system may comprise at least one processor, a pairwise similarity measurement module executable by the processor(s), and an outlier determination module executable by the processor(s). The pairwise similarity measurement module may be configured to determine a pairwise similarity measurement between each item listing in a plurality of item listings based on a comparison of at least one feature of each item listing. The outlier determination module may be configured to determine at least one outlier among the plurality of item listings using the pairwise similarity measurements,

In some embodiments, the feature(s) may comprise at least one feature from a group of features consisting of: a title, an image, a price, an attribute (e.g., brand, color), and a description. In some embodiments, each item listing in the plurality of item listings may belong to the same leaf or non-leaf category in a network-based marketplace or publication system. In some embodiments, the outlier determination module may be configured to determine the outlier(s) using at least one clustering algorithm. In some embodiments, the clustering algorithm(s) may comprise an agglomerative hierarchical clustering algorithm. In some embodiments, the clustering algorithm(s) may comprise a density-based clustering algorithm. The density-based clustering algorithm may comprise determining which of the item listings in the plurality of item listings qualifies as a core item listing based on a core threshold being met, with the core threshold being a minimum number of item listings with which an item listing needs to have at least a minimum pairwise similarity measurement, and determining that at least one item listing in the plurality of item listings is an outlier based on the item listing(s) not having at least the minimum pairwise measurement with any of the core item listings in the plurality of item listings. In some embodiments, the system may further comprise a diversity measurement module, executable by the at least one processor, configured to determine a diversity measurement of the plurality of listings. The diversity measurement may be representative of how diverse the item listings are in the plurality of listings. The outlier determination module may be configured to determine the core threshold and the minimum pairwise similarity measurement based on the diversity measurement of the plurality of listings. In some embodiments, the diversity measurement module may be configured to determine the diversity measurement using a divergence method. In some embodiments, the diversity measurement module may be configured to determine the diversity measurement using a Jensen-Shannon divergence method or a Kullback-Leibler divergence method. In some embodiments, the clustering algorithm(s) may comprise determining a plurality of clusters of item listings among the plurality of item listings based on the pairwise similarity measurements between the item listings, determining a pairwise similarity measurement between each cluster of item listings based on a mathematical function of the pairwise similarity measurements between the item listings for each cluster of item listings, and determining at least one cluster of outliers among the plurality of clusters of item listings using the pairwise similarity measurements between each cluster of item

In some embodiments, a computer-implemented method comprises determining a pairwise similarity measurement between each item listing in a plurality of item listings based on a comparison of at least one feature of each item listing, and determining at least one outlier among the plurality of item listings using the pairwise measurements.

In some embodiments, the feature(s) may comprise at least one feature from a group of features consisting of: a title, an image, a price, an attribute (e.g., brand, color), and a description. In some embodiments, each item listing in the plurality of item listings may belong to the same leaf or non-leaf category in a network-based marketplace or publication system. In some embodiments, determining the outlier(s) may comprise using at least one clustering algorithm. In some embodiments, the clustering algorithm(s) may comprise an agglomerative hierarchical clustering algorithm. In some embodiments, the clustering algorithm(s) may comprise a density-based clustering algorithm. The density-based clustering algorithm may comprise determining which of the item listings in the plurality of item listings qualifies as a core item listing based on a core threshold being met, with the core threshold being a minimum number of item listings with which an item listing needs to have at least a minimum pairwise similarity measurement, and determining that at least one item listing in the plurality of item listings is an outlier based on the item listing(s) not having at least the minimum pairwise similarity measurement with any of the core item listings in the plurality of item listings. In some embodiments, the method may further comprise determining the core threshold and the minimum pairwise similarity measurement based on a diversity measurement of the plurality of listings. The diversity measurement may be representative of how diverse the item listings are in the plurality of listings. In some embodiments, the method may further comprise determining the diversity, measurement using a divergence method. In some embodiments, the method may further comprise determining the diversity measurement using a Jensen-Shannon divergence method or a Kullback-Leibler divergence method. In some embodiments, the clustering algorithm(s) may comprise determining a plurality of clusters of item listings among the plurality of item listings based on the pairwise similarity measurements between the item listings, determining a pairwise similarity measurement between each cluster of item listings based on a mathematical function of the pairwise similarity measurements between the item listings for each cluster of item listings, and determining at least one cluster of outliers among the plurality of clusters of item listings using the pairwise similarity measurements between each cluster of item listings.

In some embodiments, a non-transitory machine-readable storage device may store a set of instructions that, when executed by at least one processor, causes the at least one processor to perform the operations or method, steps discussed within the present disclosure.

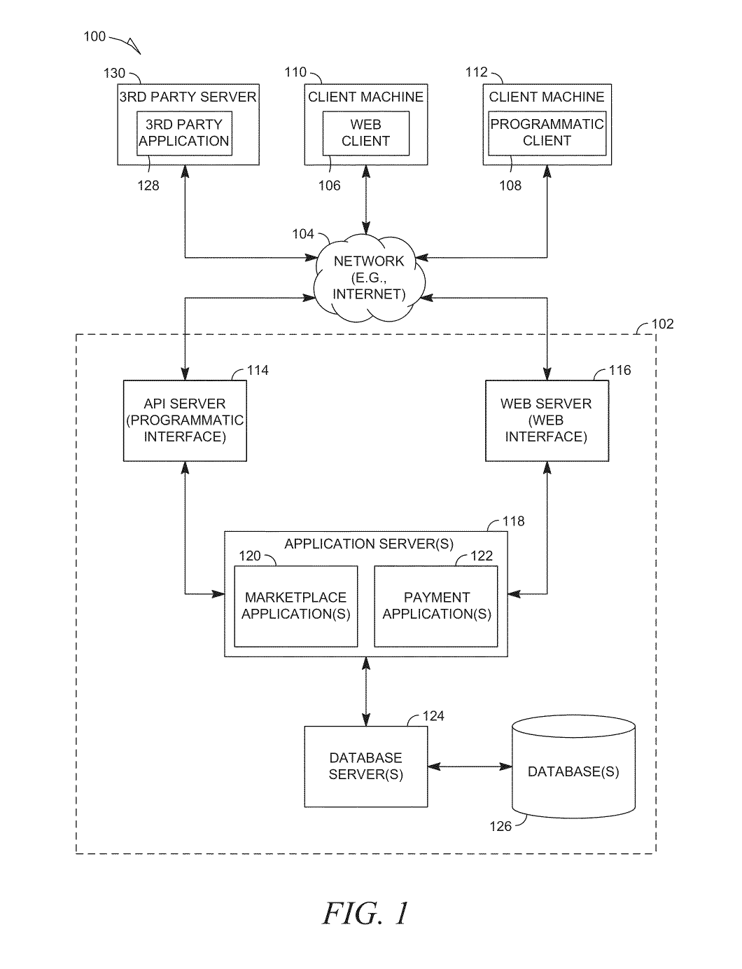

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a. proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

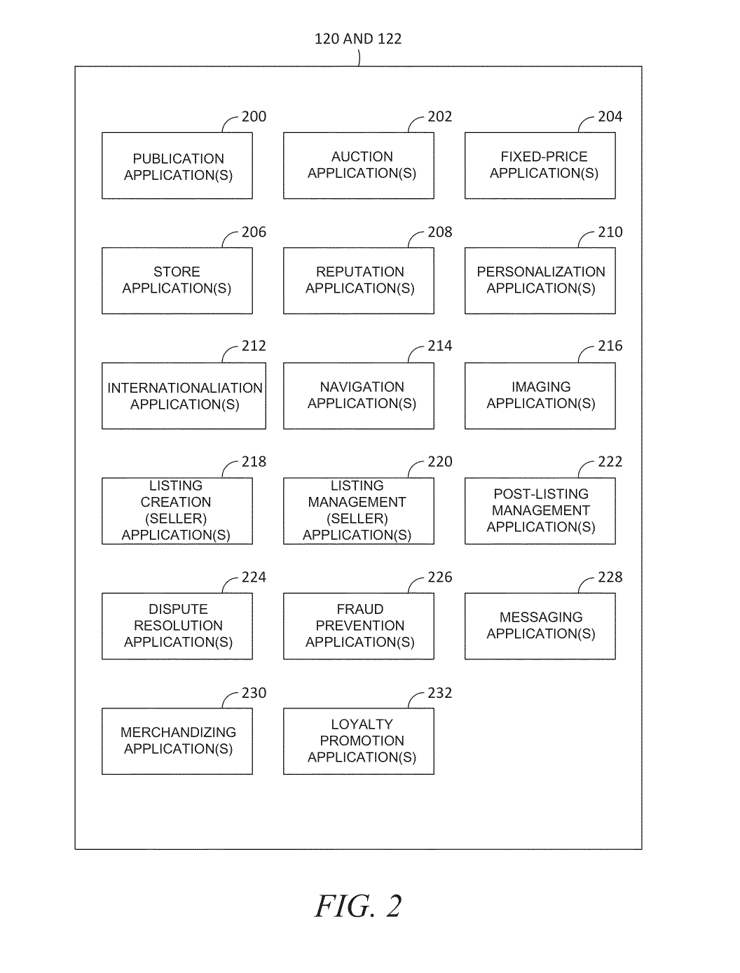

FIG. 2 is a block diagram illustrating multiple applications 120 and 122 that, in one example embodiment, are provided as part of the networked system 102. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, on as to allow information to be passed between the applications 120 and 122 or so as to allow the applications 120 and 122 to share and access common data. The applications 120 and 122 may furthermore access one or more databases 126 via the database servers 124.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (for example, through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example a user may, utilizing an appropriate personalization application 210, create a personalized reference page at which information regarding transactions to which the user is (or has been) a party may be viewed. Further, a personalization application 210 may enable a user to personalize listings and other aspects of their interactions with the networked system 102 and other parties.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may accordingly include a number of internationalization applications 212 that customize information (and/or the presentation of information) by the networked system 102 according to predetermined criteria (e.g., geographic, demographic, or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogues, or inventory data structures according to which listings may be classified within the networked system 102. Various other navigation applications 214 may be provided to supplement the search and browsing applications.

In order to make listings, available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputatio applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute, In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message OM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

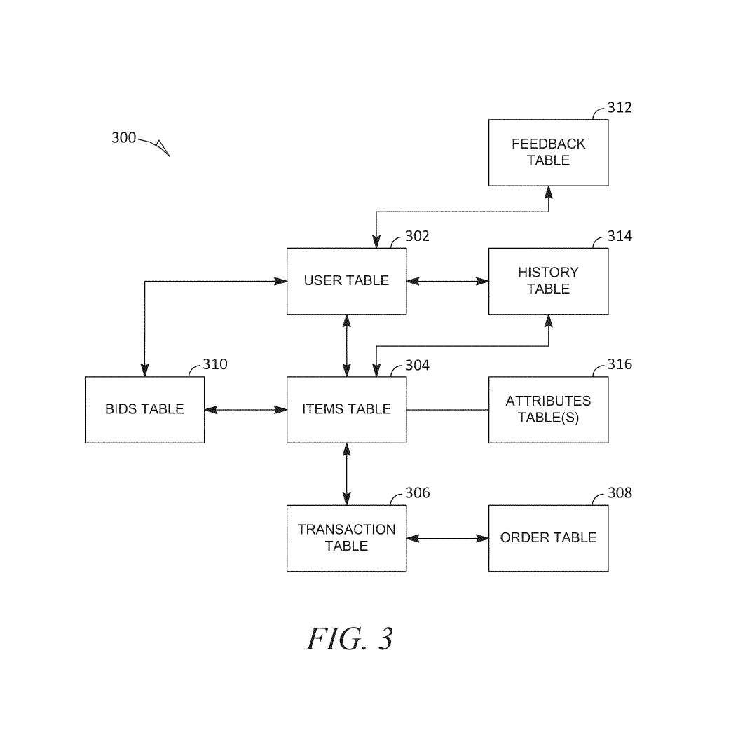

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g. a purchase or sale transaction) pertaining to items for which records exist within the items table 304.

An order table 308 is populated with order records, with each order record being associated with an order. Each order, in turn, may be associated with one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208, in one example embodiment, to construct and maintain reputation information concerning users. A history table 314 maintains a history of transactions to which a user has been a party. One or more attributes tables 316 record attribute information pertaining to items for which records exist within the items table 304, Considering only a single example of such an attribute, the attributes tables 316 may indicate a currency attribute associated with a particular item, with the currency attribute identifying the currency of a price for the relevant item as specified by a seller.

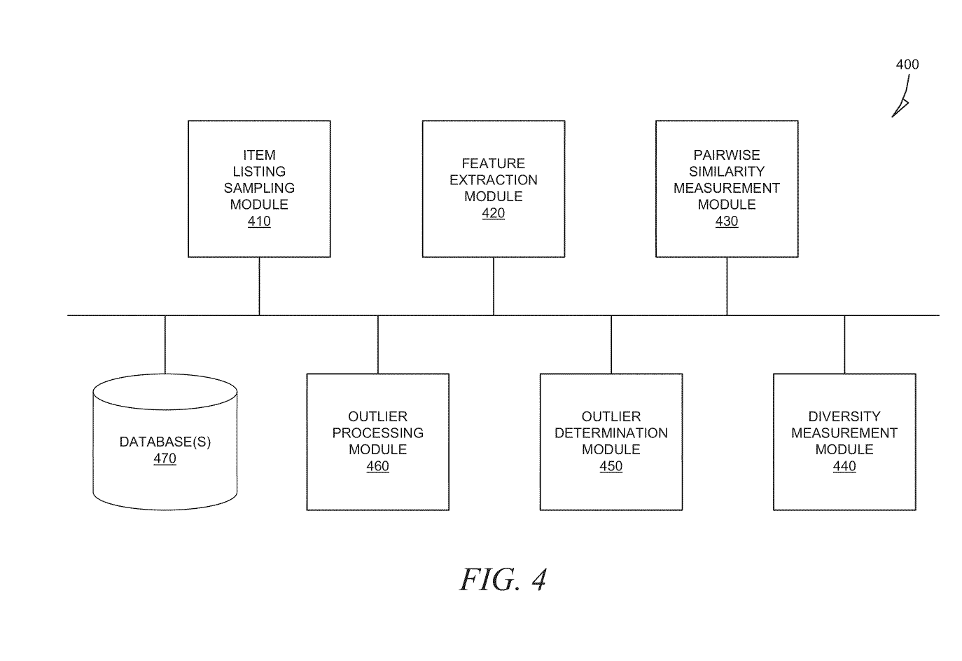

FIG. 4 is a block diagram illustrating an outlier identification system 400, in accordance with some embodiments. In some embodiments, some or all of the modules and components of the outlier identification system 400 may be incorporated into or implemented using the components of publication system 102 in FIG. 1. For example, the modules of the outlier identification system 400 may be incorporated into the application servers 118. In addition, the modules and components of FIG. 4 may have separate utility and application outside of the publication system 102 of FIG. 1.

In some embodiments, the outlier identification system 400 may comprise a pairwise similarity measurement module 430 and an outlier determination module 450. The pairwise similarity measurement module 430 may be executable by one or more processors and be configured to determine a pairwise similarity measurement between each item listing in a plurality of item listings. For example, if there were three item listings A, B, and C in the plurality of listings, the pairwise similarity measurement module 430 may determine a pairwise similarity measurement between A and B, a pairwise similarity measurement between A and C, and a pairwise similarity measurement between B and C. in some embodiments, the plurality of item listings may comprise some or all of the item listings for a. single leaf or non-leaf category. In some embodiments, the item listings may belong to a single network-based marketplace or publication system. In some embodiments, each item listing in the plurality of item listings may belong to the same leaf or non-leaf category in a network-based marketplace or publication system.

The pairwise similarity measurement module 430 may be configured to determine the pairwise similarity measurements based on a comparison of at least one feature of each item listing. For example, in the scenario above using item listings A, B, and C, the pairwise similarity measurement module 430 may determine the pairwise similarity measurement between A and B by comparing the feature(s) of A with the corresponding feature(s) of B, may determine the pairwise similarity measurement between A and C by comparing the feature(s) of A with the corresponding feature(s) of C, and may determine the pairwise similarity measurement between B and C by comparing the feature(s) of B with the corresponding feature(s) of C. These features may be any signals that may be used to determine how similar item listings are to one another. Examples of item listing features may include, but are not limited to, titles, images, prices, attributes (e.g., brand, color), descriptions, user behavior data for an item listing, and seller information, and may be in the form of text or images. It is contemplated that other types and forms of item listing features are also within the scope of the present disclosure.

In some embodiments, different features may be accorded different weights in the determination of the pairwise similarity measurements. For example, more weight may be given to item image and item description (e.g., 30% and 30%, respectively) than to item listing title and item price (e.g., 20% and 20%, respectively) in determining the pairwise similarity measurements. In some embodiments, the pairwise similarity measurement module 430 may combine the multi modal feature data into a weighted vector.

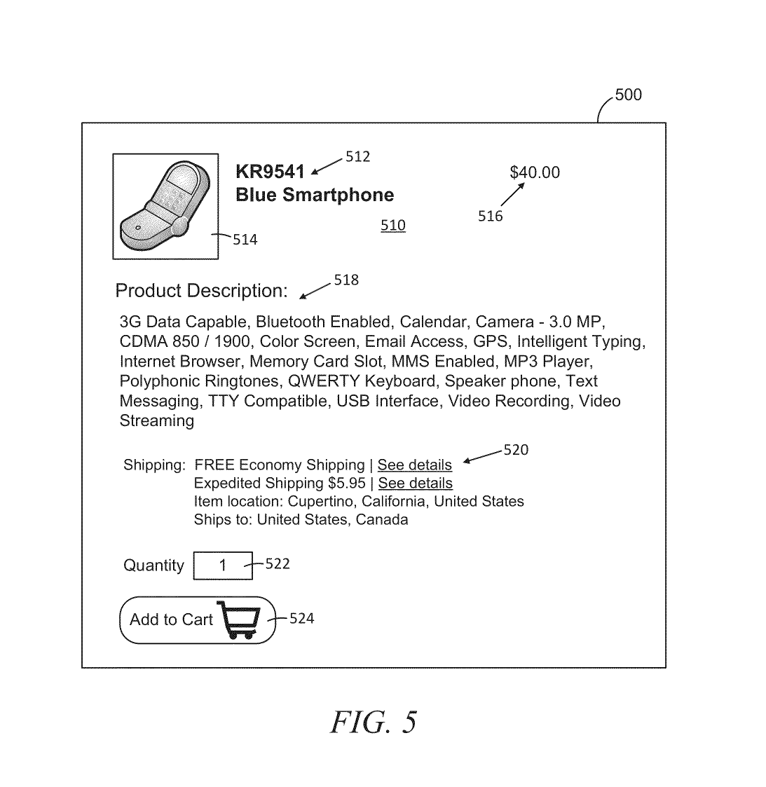

FIG. 5 illustrates an item listing 510 on an item listing page 500, in accordance with some embodiments. The item listing page 500 may be provided in response to a user selecting (e.g., clicking) a search result in a search results page or browsing through an online catalog. The item listing 510 on the item listing page 500 may comprise a title or name 512 for the item of the item listing 510, an image 514 of the item, a price 516 of the item, and a description 518 of the item. The item listing 510 may also comprise shipping options 520 for the item, as well as a quantity field 522 for a user to enter a quantity of the item the user wants to purchase, and a selectable “Add to Cart” button 524 for a user to add the entered quantity of the item to a shopping cart. It is contemplated that other configurations of the item listing page 500 and the item listing 510 are within the scope of the present disclosure. In some embodiments, any of the information in the item listing 510 may be used as an item listing feature in determining the pairwise similarity measurements. It is contemplated that, in some embodiments, metadata of the item listing 510 may be used as an item listing feature as well.

Referring back to FIG. 4, item listings may be sampled by an item listing sampling module 410, which may be executable by one or more processors. In some embodiments, the item listings may be sampled from one or more databases 470 that store item listings for a network-based marketplace or publication system. Database(s) 470 may be incorporated into the database(s) 126 in FIG. 1. In some embodiments, item listings for a single leaf or non-leaf category may be sampled. A feature extraction module 420, executable by one or more processors, may extract feature data (e.g., item listing title, image of item, description of item) from the sampled item listings. The extracted feature data may then be used to determine the pairwise similarity measurements between the sampled item listings. In some embodiments, the feature data may be stored in and extracted from the database(s) 470.

It is contemplated that the pairwise similarity measurement module 430 may calculate the pairwise similarity measurements in a variety of ways. In some embodiments, the pairwise similarity measurement module 430 may process the extracted item listing feature data and convert it into vector representations. In some embodiments, cosine similarity may be used to measure the similarity between non-binary vectors in determining the pairwise similarity measurements. If d1 and d2 are two document vectors, then cos(d1, d2)=(d1·d2)/∥d1∥ ∥d2∥ d2 is the cosine similarity measure, where—indicates the vector dot product and ∥d∥ is the magnitude of vector d.

In some embodiments, tokenization of character-based or alpha-numeric-based features (e.g., titles and descriptions) may be performed. In some embodiments, these features may be converted to lowercase. All characters in these features may he eliminated except for alphanumeric characters. Words may be split on transitions from alphabetic characters to numeric characters and on transitions from numeric characters to alphabetic characters (e.g., “32gb” may become “32 gb” and “iPhone4S” may become “iphone 4 s”). These features may then be represented as feature vectors using a bag-of-words model.

As previously mentioned, in some embodiments, feature data may be extracted from images for item listings. In some embodiments, a bag-of-visual-words representation of an image may be analogous to the bag-of-words representation of a document in traditional text processing and may be used to extract feature data from images. The first step in the bag-of-visual-words approach may be to obtain the local feature descriptors for a set of images. The scale invariant feature transform (SIFT) algorithm may be used to obtain the feature descriptors, which are key points that provide the unique signature for a portion of the image.

SIFT is a computer vision algorithm configured to detect and describe local features in images, SIFT is a robust image descriptor that represents an image as a collection of feature vectors. Using SIFT, distinctive features may be extracted from an image, which are invariant under scaling, rotation, intensity, and noise. SIFT may identify the interest points within an image and use them as unique identifiers for features within the image. Interest points may be found using Difference of Gaussian functions. SIFT's key points may be defined as the maxima and minima of the result of a Difference of Gaussian function being applied in scale-space to a series of smoothed and resampled images. SIFT's key point detection using the above approach may provide position and scale. Using the direction and magnitude of the image gradient around each point, a reference direction may be chosen. A descriptor may then be computed based on the position, scale, and rotation. The descriptor may take a grid of sub-regions around the point, and, for each sub-region, compute an image gradient orientation histogram. The histograms may be concatenated to form a descriptor vector. The SIFT setting may use 4×4 sub-regions with 8 bin orientation histograms resulting in a 128-bin histogram. SIFT features may be extracted from the image data set, and then these dense SIFT features may be clustered into a vocabulary of visual words using k-means clustering. The visual words approach may be the word document representations of images.

The set of local feature descriptors obtained using the SIFT algorithm may be quantized by clustering them in a vocabulary building step. The clusters so obtained may be represented by their cluster centers, and this set of cluster centers may constitute the codebook, vocabulary, or dictionary for the image data set. This dictionary may be projected onto each image by assigning the nearest visual word for each of the local feature descriptors of a given image. The set of visual words so obtained by the projection of the dictionary onto the image may constitute the feature vector for the image.

It is contemplated that other approaches to extracting feature data from images of item listings may also be used and are within the scope of the present disclosure.

Referring back to FIG. 4, the outlier determination module 450 may be executable by one or more processors and configured to determine at least one outlier among the plurality of item listings using the pairwise similarity measurements. The outlier determination module 450 may determine the outlier(s) among the plurality of item listings in a variety of ways. In some embodiments, the outlier determination module may be configured to determine the outlier(s using at least one clustering algorithm.

Clustering is a process that divides or clusters data into logically meaningful groups and, through this process, discovers useful information present in a large collection of data objects. Clustering aims to group data such that objects within the same group are similar, while objects in different groups are dissimilar. The greater the similarity within the objects of a cluster, and the greater the divergence between clusters, the better the clustering technique. Clustering may be used to maximize intra-cluster similarity and to minimize the inter-cluster similarity. Since clustering does not assume the presence of prior knowledge of data to be clustered, it may be classified as an unsupervised learning technique. Cluster membership may be subject to multiple definitions. A threshold may be used as a similarity measure to group objects and to determine cluster membership and object neighborhood. Clusters may also be defined as regions of high-density separated by low-density regions. This approach to clustering is mostly used to discover clusters of arbitrary size and shape, and is known as density-based clustering.

For outlier detection in leaf or non-leaf categories, clustering may be used to identify outliers. A category's item listings with high similarity may be grouped into clusters, and any item listings that do not belong to the resulting clusters may be identified and treated as outliers. In some embodiments, two types of outliers may be identified: single point outliers and cluster outliers. Single point outliers are unique outliers present in the item category that may be easily detected during implicit and explicit outlier detection phases. Cluster outliers are micro-clusters of item listings that are outliers, but have enough critical mass to be ignored while detecting implicit and explicit outliers.

In some embodiments, the clustering algorithm(s) used by the outlier determination module 450 to determine the outlier(s) may comprise an agglomerative hierarchical clustering algorithm. In some embodiments, the clustering algorithm(s) may comprise a density-based clustering algorithm. In some embodiments, the clustering algorithm(s) may comprise an agglomerative hierarchical clustering algorithm and a density-based clustering algorithm. In some embodiments, the clustering algorithm(s) may comprise determining a plurality of clusters of item listings among the plurality of item listings based on the pairwise similarity measurements between the item listings, determining a pairwise similarity measurement between each cluster of item listings based on a mathematical function of the pairwise similarity measurements between the item listings for each cluster of item listings, and determining at least one cluster of outliers among the plurality of clusters of item listings using the pairwise similarity measurements between each cluster of item listings.

Hierarchical outlier detection may use iterative hierarchical clustering of item listings to identify outliers. In some embodiments, hierarchical clustering comprises progressive clustering of the item listings. A nested sequence of partitions may be represented in the form of a binary tree structure. In a bottom-up agglomerative hierarchical clustering approach, a computational process may start with each single item listing as a single cluster. The closest clusters may then be combined incrementally at various levels, until a single universal cluster of all the item listings is formed. The intermediate levels between the single item listings and the single universal cluster of all the item listings may be viewed as clusters that are formed by proximity metrics. For example, cosine similarity scores may be used to measure the pairwise similarity measurements between the item listings. In an agglomerative hierarchical clustering scheme, each item listing may be initially assigned to an individual cluster. The closest clusters may then be iteratively merged using a chosen similarity or distance metric. Single item outliers may be obtained by choosing different levels in the hierarchical tree. This process may be performed iteratively for a predefined number of iterations to obtain single item listing outliers.

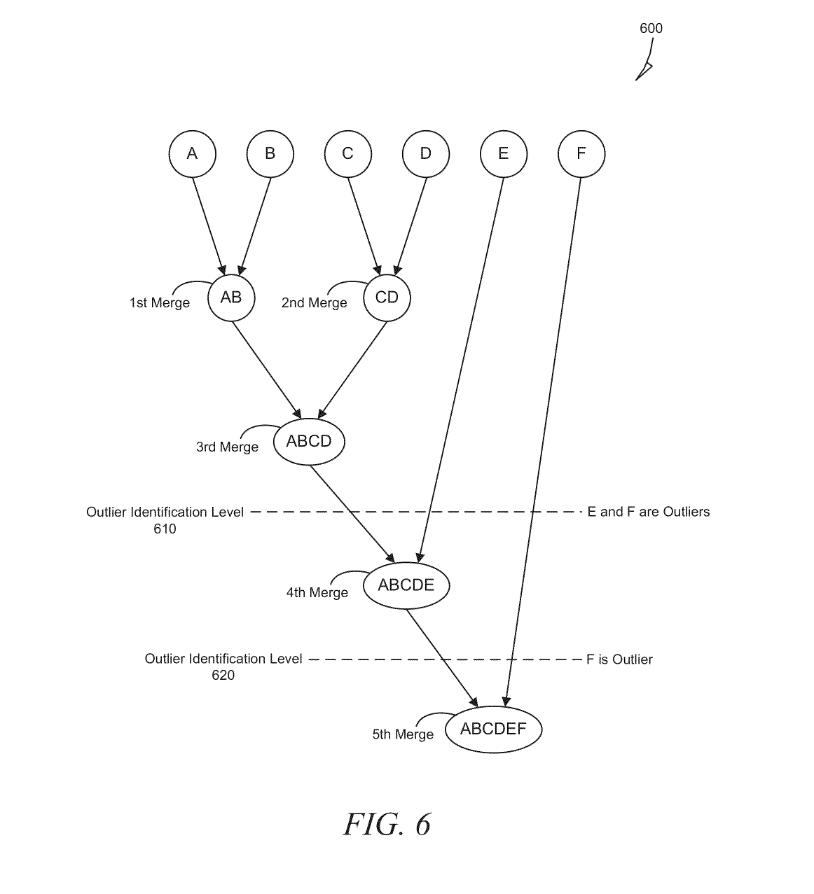

FIG. 6 illustrates a graphical representation 600 of an agglomerative hierarchical clustering algorithm, in accordance with some embodiments. In the graphical representation, individual item listings A, B, C, D, E, and F are shown. In some embodiments, each item listing may initially constitute its own cluster. Using the pairwise similarity measurements (also referred to as “pairwise distances”) between all of the item listings, the two most similar or closest item listing clusters (i.e., the item listing clusters with the highest pairwise similarity measurement or the lowest pairwise distance) may be merged into a single cluster of item listings. This merging of item listing clusters may be repeated until a single cluster of all the item listings is obtained.

For example, in FIG. 6, the pairwise similarity measurement for item listings A and B may be the highest among the item listings. As a result, item listing clusters A and B may be merged to form a single cluster of item listings A and B. This first merge of the hierarchical clustering algorithm may be represented in FIG. 6 as cluster AB. The resulting item listing clusters would then be AB, C, and F.

The pairwise similarity measurement for item listing clusters C and D may be the next highest among the clusters of item listings. As a result, item listing clusters C and D may be merged to form a single cluster of item listings C and D. This second merge of the hierarchical clustering algorithm may be represented in FIG. 6 as cluster CD. The resulting item listing clusters would be AB, CD, E, and F.

The pairwise similarity measurement for item listing clusters AB and CD may be the next highest among the clusters of item listings. As a result, item listing clusters AB and CD may be merged to form a single cluster of item listings AB and CD. This third merge of the hierarchical clustering algorithm may be represented in FIG. 6 as cluster ABCD. The resulting item listing clusters would be ABCD, E, and F.

The pairwise similarity measurement for item listing clusters ABCD and E may be the next highest among the clusters of item listings. As a result, item listing clusters ABCD and E may be merged to form a single cluster of item listings ABCD and E. This fourth merge of the hierarchical clustering algorithm may be represented in FIG. 6 as cluster ABCDE. The resulting item listing clusters would be ABCDE and F.

Since item listing clusters ABCDE and F are the only remaining item listing clusters, the fifth and final merge of the hierarchical clustering algorithm may be formed by item listing clusters ABCDE and F. This fifth merge may be represented in FIG. 6 as cluster ABCDEF.

When a cluster comprises multiple item listings, the pairwise similarity measurement between that multiple item listing cluster and another cluster, whether it be a single item listing cluster or another multiple item listing cluster, may be calculated in a variety of ways. In some embodiments, the pairwise similarity measurement between a cluster of item listings and another cluster may be determined based on a mathematical function of the pairwise similarity measurements between the individual item listings of two clusters. For example, in FIG. 6, the pairwise similarity measurement between E and A may be 3, the pairwise similarity measurement between E and B may be 4, the pairwise similarity measurement between E and C may be 5, and the pairwise similarity measurement between E and D may be 8. The pairwise similarity measurement between cluster ABCD and cluster E may he determined based on these pairwise similarity measurements between the individual item listings. In one example, the pairwise similarity measurement between cluster ABCD and cluster E may be based on the minimum value of the pairwise similarity measurement between these individual item listings, which would be 3 (the pairwise similarity measurement between E and A) in the scenario above. In another example, the pairwise similarity measurement between cluster ABCD and cluster E may be based on the maximum value of the pairwise similarity measurement between these individual item listings, which would be 8 (the pairwise similarity measurement between E and D) in the scenario above. In yet another example, the pairwise similarity measurement between cluster ABCD and cluster E may be based on the average value of the pairwise similarity measurement between these individual item listings, which would be 5 (3+4+5+8=20→20/4=5) in the scenario above. It is contemplated that other ways of calculating the pairwise similarity measurement between a multiple item listing cluster and another cluster may also be employed.

Outliers may be identified by finding all of the unmerged or unclustered item listings at a chosen level of the hierarchical tree. For example, in FIG. 6, if outlier identification level 610 is the chosen level, then item listings E and F may be the outliers, since they are both single item listings that have not been merged or clustered with any other item listing at that level. If outlier identification level 620 is the chosen level, then item listing F may be the outlier, since it is a single item listing that has not been merged, or clustered, with any other item listing at that level,

In some embodiments, density-based clustering may be used to identify micro-cluster item listing outliers and single item listing outliers in a leaf or non-leaf category. Density-based clustering techniques define clusters as dense regions separated by sparsely populated regions. Density of a region may be measured by either a simple count of the objects or by using complex models for density determination. Density-based techniques are useful for detecting arbitrarily shaped clusters in noisy settings.

A density-based clustering algorithm for outlier detection may perform clustering by trying to identify the structural similarity of nodes. In this approach, item listings with the same or similar structural similarity may be part of the same cluster. In some embodiments, an item listing may be classified as a cluster member, as an outlier (noise), or as a hub. This density-based clustering approach for outlier detection may be based on the concept of structural similarity, where members of the same cluster have many similar adjacent members irrespective of the size of the cluster. Structural similarity is a measure of commonality of two adjacent nodes. In some embodiments, the structural similarity of two adjacent nodes v, w can be given by

$$σ ( v , w ) = \frac{\vert Γ ( v ) ⋂ Γ ( w ) \vert}{\sqrt{\vert Γ ( v ) \vert \vert Γ ( w ) \vert}} ,$$

where Γ(x) is the immediate neighborhood of item listing x. However, it is contemplated that the structural similarity may be calculated in other ways as well. Structural similarity may be large for members of the same cluster and may be small for hubs and outliers.

As previously mentioned, in some embodiments, density-based clustering may be used to identify outliers among a plurality of item listings. In some embodiments, a graph of the item listings may be constructed, where edges may be introduced between item listings having a similarity measurement above a certain threshold, which may be referred to as the neighborhood threshold. Item listings that have a similarity measurement above this neighborhood threshold may be referred to as neighbors. In some embodiments, this similarity measurement is the pairwise similarity measurement previously discussed. The neighborhood threshold introduces the concepts of neighborhood, connectivity, and reachability amongst the item listings.

Item listings that have or exceed a certain number of edges (i.e., directly connected to a certain number of item listings) may be identified as core item listings. This number may be referred to as the core threshold. If two core item listings are each other's neighbor, then they may be considered to be in the same cluster and directly density reachable.

Item listings that do not have an edge with any of the other item listings may be identified as explicit outliers. Core item listings and their adjoining item listings may be merged to into clusters using the neighborhood threshold. Item listings that did not get merged into a cluster may be identified as implicit outliers. Single item listing outliers may be identified using the identified implicit and explicit outliers.

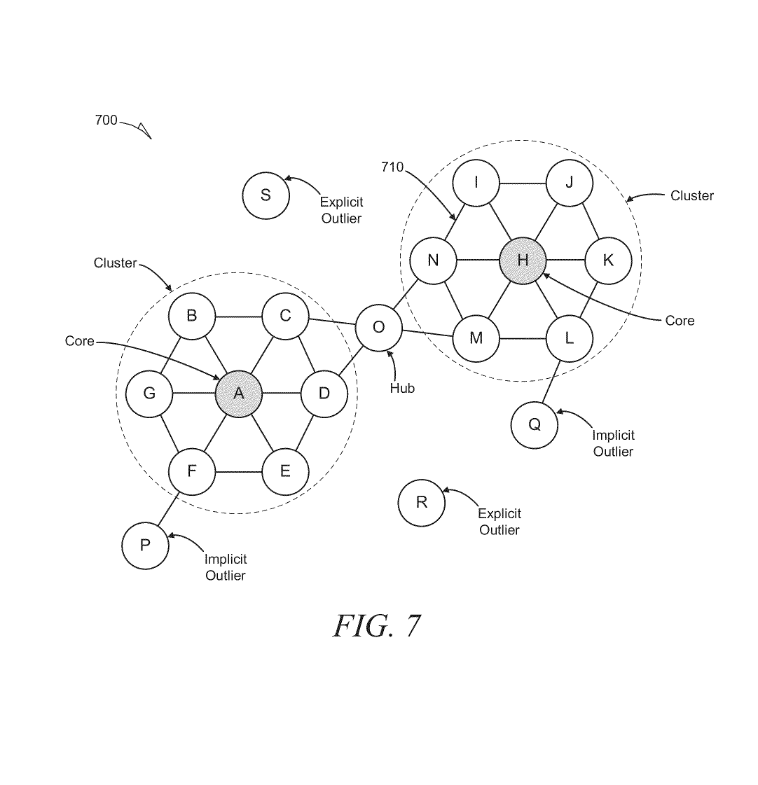

FIG, 7 illustrates a graphical representation 700 of a density-based clustering algorithm, in accordance with some embodiments. In FIG. 7, item listings A-S may belong to the same leaf or non-leaf category in a network-based marketplace or publication system. Edges 710 may be introduced between, and directly connect, any two item listings having a pairwise similarity measurement that meets a predetermined neighborhood threshold. For example, item listing A may have a pairwise similarity measurement with each of item listings B, C, D, E, F, and G that meets the neighborhood threshold, thereby resulting in an edge 710 directly connecting item listing A with each of item listings B, C, D, E, F, and G. Item listing P may have only one pairwise similarity measurement with another item listing, item listing F, that meets the neighborhood threshold, thereby resulting in an edge 710 directly connecting item listing P with item listing F. Item listing R may have no pairwise similarity measurement with another item listing that meets the neighborhood threshold, thereby resulting in item listing R not being directly connected with any other item listing.

In some embodiments, item listings that do not have an edge 710 with any other item listings may be identified as explicit outliers. For example, in FIG. 7, item listings R and S do not have an edge 710 with any other item listings. Therefore, item listings R and S may be identified as explicit outliers.

In some embodiments, a core threshold may be set for identifying core item listings. For example, in FIG. 7, the core threshold may be five. Since item listings A and H are the only item listings that are directly connected to five or more other item listings (they are each directly connected to six item listings), item listings A and H may be identified as core item listings.

In some embodiments, item listings that do not have an edge 710 with any core item listings may be identified as implicit outliers. For example, in FIG. 7, neither item listing P nor item listing Q have an edge 710 with either core item listing A or core item listing H. Therefore, item listings P and Q may be identified as implicit outliers.

In some embodiments, the item listings that do not have an edge 710 with a core item listing may be determined not to be part of that core item listing's cluster or neighborhood. However, these same item listings may act as bridges between clusters. Such item listings may be referred to as hub item listings. An item listing that does not have an edge 710 with any core item listing may escape being identified as an outlier if it qualifies as a hub item listing. For example, in FIG. 7, item listing O may qualify as a hub item listing, as it acts as a bridge between the cluster of core item listing A and the cluster of core item listing H.

Multiple item listing clusters may be identified. For example, in FIG. 7, two item listing clusters may be identified: (1) the cluster of core item listing A with neighbor item listings B, C, D, F, F, and G; and (2) the cluster of core item listing H with neighbor item listings I, J, K, L, M, and N. In some scenarios, certain item listings that should be identified as outliers for a leaf category may avoid being identified as outliers for the leaf category because they have enough neighbors to form a cluster. For example, in a leaf category for televisions, there may be a cluster of item listings for Sony televisions, a cluster of item listings for Samsung televisions, a cluster of item listings for Vizio televisions, and a cluster of item listings for television warranties. While the item listings in the clusters for the Sony televisions, the Samsung televisions, and the Vizio televisions may be correctly assigned to the leaf category for televisions, the item listings in the cluster for television warranties may be miscategorized. If there is a sufficient number of similarly miscategorized item listings, such as the item listings for television warranties assigned to the leaf category for televisions, to meet the core threshold, then these miscategorized item listings may escape being identified as outliers.

In order to avoid clusters of miscategorized item listings not being identified as outliers, each cluster may be treated as an individual item listing and a single feature vector may be formed from all of the item listings that belong to the cluster. One or more clustering algorithms may then be used to identify the cluster outliers. For example, in the scenario above, the cluster of item listings for Sony televisions, the cluster of item listings for Samsung televisions, the cluster of item listings for Vizio televisions, and the cluster of item listings for television warranties may each be treated as individual item listings and a single feature vector may he formed for each cluster from their constituent item listings. These newly formed feature vectors may then be used to determine which of the clusters comprises outlier item listings. For example, an agglomerative hierarchical clustering algorithm may be used on the four clusters above and determine that the cluster of television warranties is an outlier for the leaf category for televisions.

In some embodiments, once an item listing outlier is identified, that identification of the outlier may be used in subsequent processing. For example, the identified outlier may be demoted in search results or eliminated from the leaf or non-leaf category. It is contemplated that other actions may be performed as well. Referring back to FIG. 4, an outlier processing module 460 may use the identification of any outliers to perform such processing. In some embodiments, the outlier processing module 460 may make changes (e.g., demotion or elimination of the outliers) to one or more databases (e.g., database(s) 470) that are involved in the supplying item listing information in a network-based marketplace or publication system.

In some embodiments, certain parameters that may be used in determining outliers for a category may be set or adjusted based on the diversity level of that category. The more diverse a category is, the more difficult it may be to determine whether an item listing is an outlier for that category. Since it may be more difficult to identify outliers in a category that is more diverse, the higher the diversity of a category, the lower the neighborhood threshold and/or the core threshold may be set. In some embodiments, the thresholds and/or other parameters of the outlier determination algorithms (e.g., agglomerative hierarchical clustering algorithm, density-based clustering algorithm) may be determined based on the diversity of the category for which the outliers are trying to be determined. In some embodiments, one or more parameters of one or more outlier determination algorithms may be set as a mathematical function of the diversity level of the category. It is contemplated that the diversity level, or score, of a category may be determined in a variety of ways. In some embodiments, the diversity level of a category may be determined using a divergence method. In some embodiments, the diversity level of a category may be determined using a Jensen-Shannon divergence method or a Kullback-Liebler divergence method. In some embodiments, the divergence of an item listing is obtained by comparing its feature distribution with the corresponding category feature distribution. The diversity of a category may be the average divergence of all of the item listings in the category. It is contemplated that other methods of determining the diversity level of a category are also within the scope of the present invention. Referring back to FIG. 4, a diversity measurement module 440 may be configured to determine a diversity measurement for a category. The diversity measurement module, 440 may then use this diversity measurement to set the parameters for one or more outlier detection algorithms, or may provide the diversity measurement to another module (e.g., the outlier determination module 450) that may use it to set the parameter for one or more outlier detection algorithms.

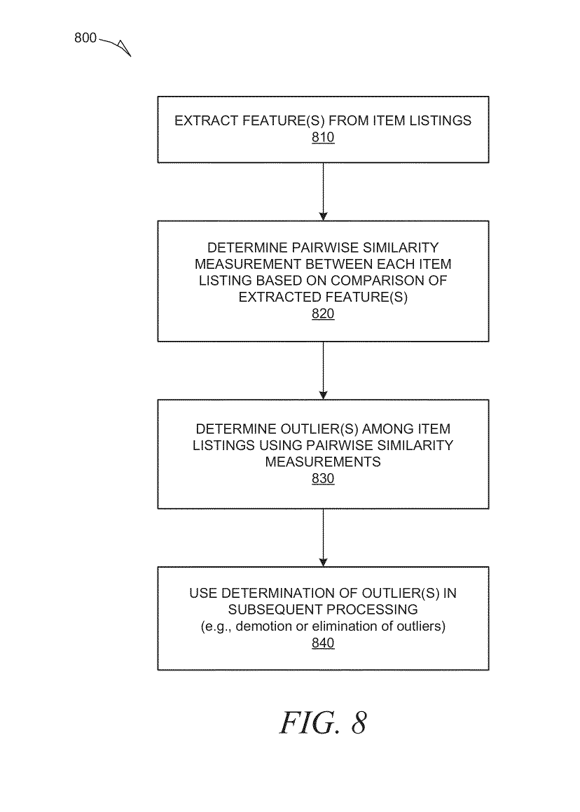

FIG. 8 is a flowchart illustrating a method 800 for identifying outliers, in accordance with some embodiments. The operations of method 800 may be performed by a system or modules of a system (e.g., system 400 or any of its modules). At operation 810, one or more features may be extracted from a plurality of item listings. In some embodiments, the item listings may belong to the same leaf or non-leaf category in a network-based marketplace or publication system. At operation 820, a pairwise similarity measurement between each item listing in a plurality of item listings may be determined based on a comparison of the extracted feature(s) of each item listing. At operation 830, at least one outlier among the plurality of item listings may be determined using the pairwise similarity measurements. In some embodiments, this determination may be made using one or more clustering algorithms. In some embodiments, this determination may be made using an agglomerative hierarchical clustering algorithm and/or a density-based clustering algorithm. At operation 840, the determination of the outlier(s) may be used in subsequent processing. For example, the outlier(s) may be demoted or hidden in search results or removed from inventory. It is contemplated that the operations of method 800 may incorporate any of the other features disclosed herein. Furthermore, the operations of method 800 may be reiterated with updated pairwise similarity measurements between extracted features from new item listings.

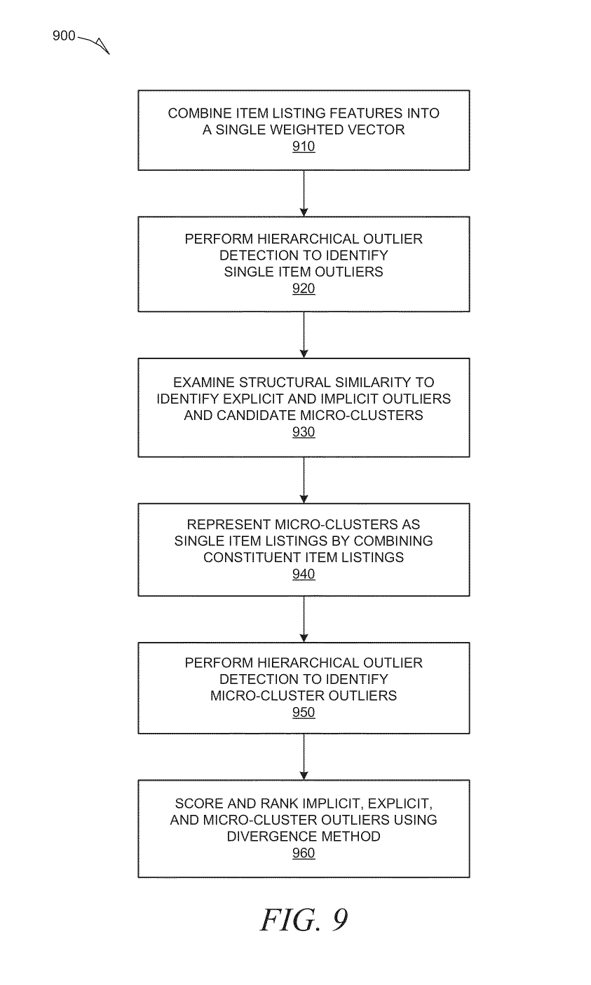

FIG. 9 is a flowchart illustrating another method 900 of identifying outliers, in accordance with some embodiments. The operations of method 900 may be performed by a system or modules of a system (e.g., system 400 or any of its modules). At operation 910, features that are specific to item listings in a plurality of item listings may be combined into a single weighted vector for each item listing. At operation 920, a hierarchical outlier detection method may be performed using the single weighted vectors in order to identify single item listing outliers. At operation 930, the structural similarity of the item listings may be examined to identify explicit and implicit outliers and candidate micro-clusters. At operation 940, the candidate micro-clusters may be represented as single item listings by combining their constituent item listings. At operation 950, a hierarchical outlier detection method may be performed using the candidate micro-clusters, each represented as a single item listing, to identify micro-cluster outliers. At operation 960, implicit, explicit, and micro-cluster outliers may be scored and ranked using a divergence computing method. In some embodiments, the divergence computing method may comprise a Jensen-Shannon divergence method or a Kullback-Liebler divergence method. It is contemplated that the operations of method 900 may incorporate any of the other features disclosed herein.

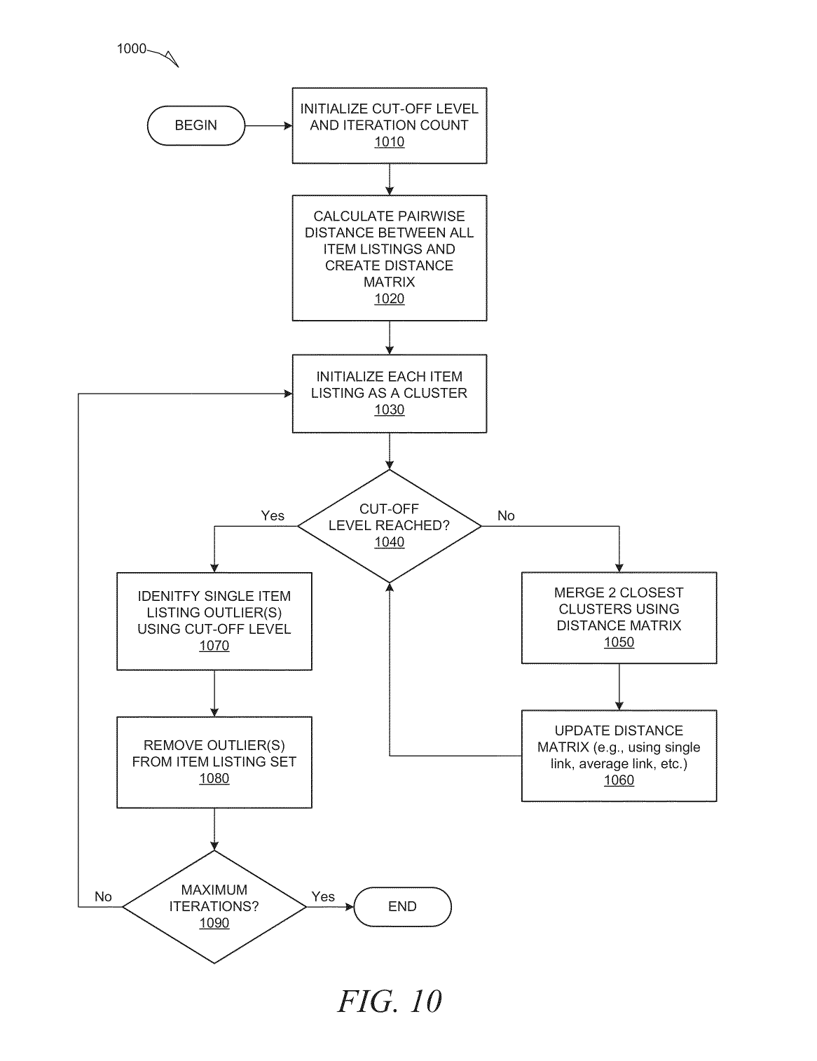

FIG. 10 is a flowchart illustrating yet another method 1000 of identifying outliers, in accordance with some embodiments. The operations of method 1000 may be performed by a system or modules of a system (e.g., system 400 or any of its modules). At operation 1010, a cut-off level and an iteration count may be initialized. At operation 1020, the pairwise distance e.g., the pairwise similarity measurement) between all item listings in a plurality of item listings may be calculated, and a distance matrix may be created using the calculated distances. At operation 1030, each item listing may be initialized as a cluster. At operation 1040, it may be determined whether or not the cut-off level has been reached. The cut-off level may be the outlier identification level (e.g., outlier identification level 610 or 620) discussed with respect to FIG. 6. If the cut-off level has not been reached, then the method 1000 may proceed to operation 1050, where the two closest clusters may be merged using the distance matrix. At operation 1060, the distance matrix may be updated to in order to account for the newly merged clusters. The distance matrix may be updated by calculating the pairwise distances using a single linkage method or an average linkage method. It is contemplated that other methods of updating the distance matrix may be used as well. The method 1000 may then return to operation 1040. If it is determined at operation 1040 that the cut-off level has been reached, then the method 1000 may proceed to operation 1070, where one or more single item listing outliers may be identified using the cut-off level (e.g., as described with respect to FIG. 6). At operation 1080, the identified outlier(s) may then be removed from the set of item listings (e.g., removed from the item category), and the iteration count may be updated. At operation 1090, it is determined whether the maximum amount of iterations has been reached. If the maximum amount of iterations has not been reached, then the method 1000 may return to operation 1030. If the maximum amount of iterations has been reached, then the method 1000 may end. It is contemplated that the operations of method 1000 may incorporate any of the other features disclosed herein.

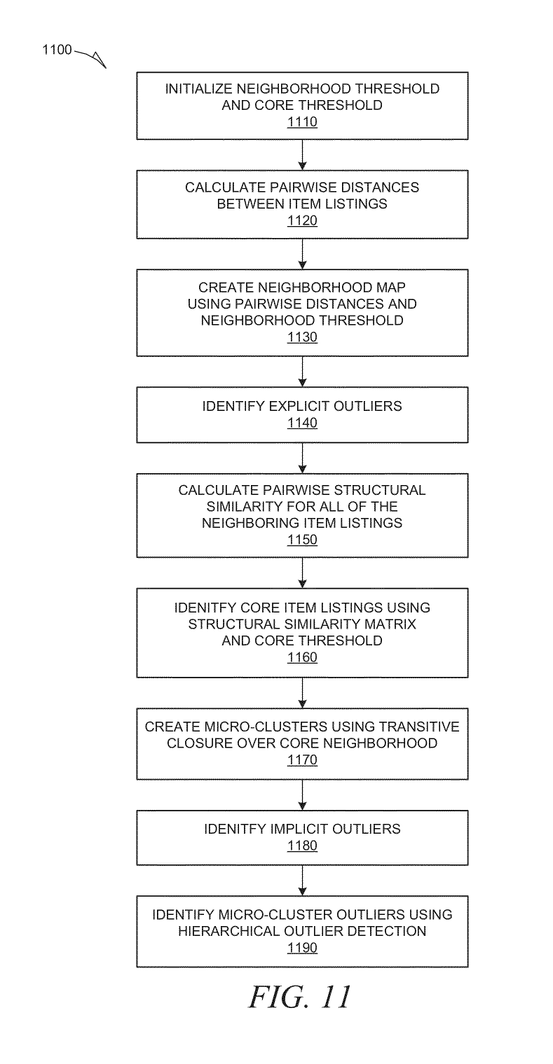

FIG. 11 is a flowchart illustrating yet another method 1100 of identifying outliers, in accordance with some embodiments. The operations of method 1100 may be performed by a system or modules of a system (e.g., system 400 or any of its modules). At operation 1110, a neighborhood threshold and a core threshold may be initialized. At operation 1120, pairwise distances (e.g., pairwise similarity measurements) between all item listings in a plurality of item listings may be calculated. At operation 1130, a neighborhood map may be created using the pairwise distances and the neighborhood threshold. At operation 1140, explicit outliers among the plurality of item listings may be identified using the neighborhood map. At operation 1150, the pairwise structural similarity for all of the neighboring item listings in the neighborhood map may be calculated and used to form a structural similarity matrix. At operation 1160, core item listings may be identified using the structural similarity matrix and the core threshold. At operation 1170, micro-clusters may be created using transitive closure over the neighborhood of any core item listings. At operation 1180, implicit outliers among the plurality of item listings may be identified. At operation 1190, micro-cluster outliers may be identified using a hierarchical outlier detection method (e.g., an agglomerative hierarchical clustering algorithm). It is contemplated that the operations of method 1100 may incorporate any of the other features disclosed herein.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously; communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e,g., a collection of information).

The various operations of example methods described herein may y be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable fir use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

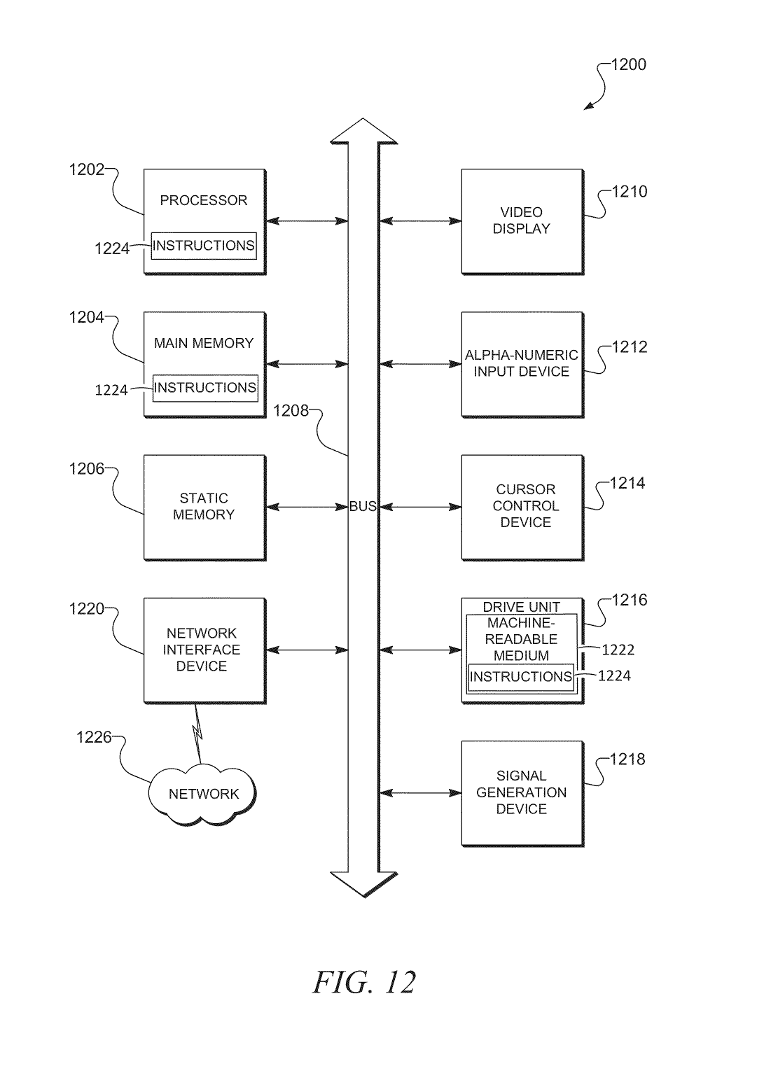

FIG. 12 is a block diagram of a machine in the example form of a computer system 1200 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a user interface (UI) navigation (or cursor control) device 1214 (e.g., a mouse, a disk drive unit 1216, a signal generation device 1218 (e.g., a speaker), and a network interface device 1220.

### Machine-Readable Medium

The disk drive unit 1216 includes a machine-readable medium 1222 on which is stored one or more sets of data structures and instructions 1224 (e.g., software) embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media. The instructions 1224 may also reside, completely or at least partially, within the static memory 1206.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc or digital video disc) read-only memory (DVD-ROM) disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
at least one processor;
a pairwise similarity measurement module, executable by the at least one processor, configured to determine a pairwise similarity measurement between each item listing in a plurality of item listings based on a comparison of at least one feature of each item listing; and
an outlier determination module, executable by the at least one processor, configured to determine at least one outlier among the plurality of item listings using the pairwise similarity measurements.

2. The system of claim 1, wherein the at least one feature comprises at least one feature from a group of features consisting of: a title, an image, a price, an attribute, and a description.

3. The system of claim 1, wherein each item listing in the plurality of item listings belongs to the same category in a network-based marketplace or publication system.

4. The system of claim 1, wherein the outlier determination module is configured to determine the at least one outlier using at least one clustering algorithm.

5. The system of claim 4, wherein the at least one clustering algorithm comprises an agglomerative hierarchical clustering algorithm.

6. The system of claim 4, wherein the at least one clustering algorithm comprises a density-based clustering algorithm, the density-based clustering algorithm being configured to:
determine which of the item listings in the plurality of item listings qualifies as a core item listing based on a core threshold being met, the core threshold being a minimum number of item listings with which an item listing needs to have at least a minimum pairwise similarity measurement; and
determine that at least one item listing in the plurality of item listings is the at least one outlier based on the at least one item listing not having at least the minimum pairwise similarity measurement with any of the core item listings in the plurality of item listings.

7. The system of claim 6, further comprising a diversity measurement module, executable by the at least one processor, configured to determine a diversity measurement of the plurality of listings, the diversity measurement being representative of how diverse the item listings are in the plurality of listings, wherein the outlier determination module is configured to determine the core threshold and the minimum pairwise similarity measurement based on the diversity measurement of the plurality of listings.

8. The system of claim 7, wherein the diversity measurement module is configured to determine the diversity measurement using a Jensen-Shannon divergence method or a Kullback-Liebler divergence method.

9. The system of claim 4, wherein the at least one clustering algorithm is configured to:
determine a plurality of clusters of item listings among the plurality of item listings based on the pairwise similarity measurements between the item listings;
determine a pairwise similarity measurement between each cluster of item listings based on a mathematical function of the pairwise similarity measurements between the item listings for each cluster of item listings; and
determine at least one cluster of outliers among the plurality of clusters of item listings using the pairwise similarity measurements between each cluster of item listings.

10. A computer-implemented method comprising:
determining a pairwise similarity measurement between each item listing in a plurality of item listings based on a comparison of at least one feature of each item listing; and
determining at least one outlier among the plurality of item listings using the pairwise similarity measurements.

11. The method of claim 10, wherein the at least one feature comprises at least one feature from a group of features consisting of: a title, an image, a price, an attribute, and a description.

12. The method of claim 10, wherein each item listing in the plurality of item listings belongs to the same category in a network-based marketplace or publication system.

13. The method of claim 10, wherein determining the at least one outlier comprises using at least one clustering algorithm.

14. The method of claim 13, wherein the at least one clustering algorithm comprises an agglomerative hierarchical clustering algorithm.

15. The method of claim 13, wherein the at least one clustering algorithm comprises a density-based clustering algorithm, the density-based clustering algorithm being configured to:
determine which of the item listings in the plurality of item listings qualifies as a core item listing based on a core threshold being met, the core threshold being a minimum number of item listings with which an item listing needs to have at least a minimum pairwise similarity measurement; and
determine that at least one item listing in the plurality of item listings is the at least one outlier based on the at least one item listing not having at least the minimum pairwise similarity measurement with any of the core item listings in the plurality of item listings.

16. The method of claim 15, further comprising determining the core threshold and the minimum pairwise similarity measurement based on a diversity measurement of the plurality of listings, the diversity measurement being representative of how diverse the item listings are in the plurality of listings.

17. The method of claim 16, further comprising determining the diversity measurement using a Jensen-Shannon divergence method or a Kullback-Liebler divergence method.

18. The method of claim 10, wherein the at least one clustering algorithm is configured to:
determine a plurality of clusters of item listings among the plurality of item listings based on the pairwise similarity measurements between the item listings;
determine a pairwise similarity measurement between each cluster of item listings based on a mathematical function of the pairwise similarity measurements between the item listings for each cluster of item listings; and
determine at least one cluster of outliers among the plurality of clusters of item listings using the pairwise similarity measurements between each cluster of item listings.

19. A non-transitory machine-readable storage device storing a set of instructions that, when executed by at least one processor, causes the at least one processor to perform a set of operations comprising:
determining a pairwise similarity measurement between each item listing in a plurality of item listings based on a comparison of at least one feature of each item listing; and
determining at least one outlier among the plurality of item listings using the pairwise similarity measurements.

20. The machine-readable storage device of claim 15, wherein:
the at least one feature comprises at least one feature from a group of features consisting of a title, an image, a price, an attribute, and a description;
each item listing in the plurality of item listings belongs to the same leaf category in a network-based marketplace or publication system; and.
determining the at least one outlier comprises using at least one clustering algorithm.
